(19) United States
(12) Patent Application Publication
(10) Pub. No.: US 2025/0158781 A1
(43) Pub. Date: May 15, 2025

(54) COVERAGE ENHANCEMENT

(71) Applicant: ZTE CORPORATION, Shenzhen (CN)

(72) Inventors: Fangyu CUI, Shenzhen (CN); Nan ZHANG, Shenzhen (CN); Junli LI, Shenzhen (CN); Yachao YIN, Shenzhen (CN)

(73) Assignee: ZTE CORPORATION, Shenzhen (CN)

(21) Appl. No.: 19/020,720

(22) Filed: Jan. 14, 2025

Related U.S. Application Data
(63) Continuation of application No. PCT/CN2022/112345, filed on Aug. 14, 2022.

(51) Int. Cl. H04L 5/00; H04B 7/185

(52) U.S. Cl. CPC H04L 5/0053; H04B 7/18513

(57) ABSTRACT

Systems, methods, and apparatus for wireless communication are described. A wireless communication method includes receiving, by a wireless device, a number of signals in a signal burst. The method further includes performing, by the wireless device, further communication based on the number of signals. The described techniques may be adopted by a network device or by a wireless device.

### CROSS-REFERENCE TO RELATED APPLICATION

This application claims the benefit of priority under 35 U.S.C. § 120 as a continuation of PCT Patent Application No. PCT/CN2022/112345, filed on Aug. 14, 2022, the disclosure of which is incorporated herein by reference in its entirety.

### TECHNICAL FIELD

This patent document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability, and other emerging business needs.

### SUMMARY

Techniques are disclosed for enhancing connections between User Equipment (UE) and Non-Terrestrial Networks (NTNs).

A first example wireless communication method includes receiving, by a wireless device, a number of signals in a signal burst. The method further includes performing, by the wireless device, further communication based on the number of signals.

A second example wireless communication method includes receiving, by a wireless device, an indication of resources used for a downlink transmission. The method further includes performing, by the wireless device, further communication based on the indication of resources.

A third example wireless communication method includes receiving, by a wireless device, configuration information for a shared data channel. The method further includes performing, by the wireless device, further communication based on the configuration information.

A fourth example wireless communication method includes receiving, by a wireless device, multiple repetitions of a message4 (Msg4) in random access. The method further includes performing, by the wireless device, further communication based on the multiple repetitions of the Msg4.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWING

FIG. 1 illustrates an exemplary diagram of a Non-Terrestrial Network (NTN).

FIG. 2 illustrates an exemplary Synchronization Signal Block (SSB) transmission.

FIG. 3 illustrates an exemplary SSB transmission with a Quasi-Co-Location (QCL) window.

FIG. 4 is an exemplary flowchart for reception of a number of signals.

FIG. 5 is an exemplary flowchart for reception of an indication of resources.

FIG. 6 is an exemplary flowchart for reception of configuration information.

FIG. 7 is an exemplary flowchart for reception of data with multiple repetitions.

FIG. 8 illustrates an exemplary block diagram of a hardware platform that may be a part of a network device or a communication device.

FIG. 9 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

Non-Terrestrial Networks (NTNs) have been supported in 3GPP. However, for User Equipment (UE) devices such as smartphones, direct access to NTNs may not be available due to low antenna gain. In order to support direct access from smartphones to NTNs, methods for coverage enhancement are investigated in this patent document.

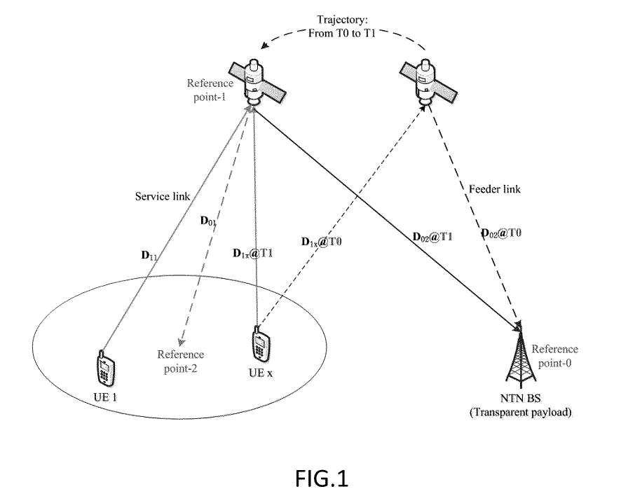

The structure of transparent NTN is illustrated in FIG. 1. The link between UE and satellite is service link. The link between BS and satellite is feeder link and is common for all UEs within the same cell.

In legacy systems, the following methods have been considered for coverage enhancement:

(1) Repetition: The transmitter can repetitively transmit the message for a period of time. Then, the receiver can combine the repetition and increase the performance of decoding.

(2) Aggregation: For PDCCH transmission, the time-frequency resources are divided into multiple control channel elements (CCEs). Multiple CCEs can be aggregated to transmit one PDCCH. With higher aggregation level, more time-frequency resources will be used to transmit a message, i.e., lower code-rate will be achieved and better decoding performance can be expected.

(3) Joint channel estimation: For channel estimation, the RSs at different time instances can be used jointly to estimate channel, which provides better estimation of channel and better decoding performance can be expected. In this method, the RSs for channel estimation should be QCLed.

### II. Embodiment 1

Joint channel estimation and coherent combination in SSB detection.

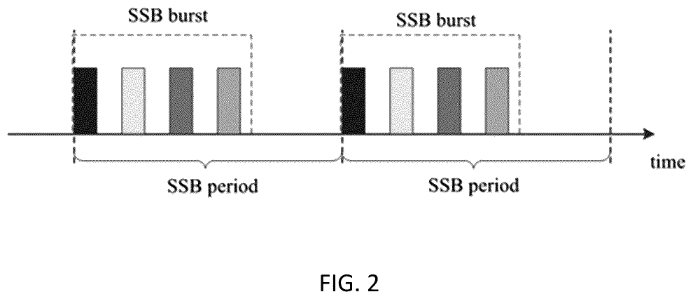

In legacy NR, the SSB transmission is as shown in FIG. 2. SSB burst is periodically transmitted by network. And in each SSB burst, multiple SSBs can be transmitted with certain pattern. The SSBs at same place in each SSB burst can be assumed to be the same. However, different SSBs in the same SSB burst are not ensured to be the same or QCLed.

In initial access, the SSB period is assumed as 20 ms. With such large interval, the channel coherence is very weak. Therefore, it is hard to perform joint channel estimation or coherent combination between SSBs in different SSB burst.

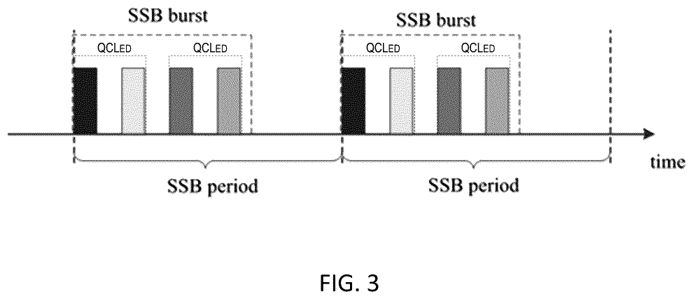

In order to obtain the gain, JCE should be considered performed within SSB burst, where the intervals between adjacent SSBs is much shorter. In this case, the SSBs used for JCE should be QCLed. Otherwise, the SSBs may experience different channels and JCE cannot be performed. However, in legacy NR, there is no such restriction. As a result, if JCE within SSB burst is supported, UE should know which of the SSBs are QCLed. A simple method is to define a QCL window, which indicates how many consecutive SSBs in a SSB burst can be treated as QCLed. For example, FIG. 3 illustrates the case where the QCL window length is 2. The QCL window may be pre-defined or indicated by network. Another method is to define new SSB patterns, where multiple SSBs in a SSB burst are QCLed.

If the gain of coherent combination (e.g., in PSS/SSS detection and time/frequency synchronization) is expected, the combination should also be considered performed within SSB burst. In this case, the SSBs to be combined should be the same or have the same SSB index. Of course there is no such restriction in legacy NR. Therefore, in order to support coherent combination within SSB burst, UE should know which of the SSBs are the same or have the same SSB index. A simple method is to define a SSB index window, which indicates how many consecutive SSBs in a SSB burst can be treated as the same or have the same SSB index. The definition of the SSB index window is similar to the QCL window in the above paragraph. Another method is to define new SSB patterns, where multiple SSBs in a SSB burst are the same or have the same SSB index.

Moreover, if multiple SSBs share the same SSB index, the PRACH resources mapped with these SSBs can be combined. That is, for UEs to successfully decode any of the SSBs sharing the same SSB index within a SSB burst, the same PRACH resource set will be used for random access.

Overall, in order to support the above functions, at least one of the following may be supported:
1. A QCL window is determined by UE based on:
(1) Predefined/Prestored QCL window length;
(2) Network type and/or predefined/prestored QCL window length table;
(3) Indicated by network through RRC signaling.
2. A SSB index window is determined by UE based on:
(1) Predefined/Prestored SSB index window length;
(2) Network type and/or predefined/prestored SSB index window length table;
(3) Indicated by network through RRC signaling.
3. At least one SSB pattern is defined, where multiple SSBs in a SSB burst are QCLed.
4. At least one SSB pattern is defined, where multiple SSBs in a SSB burst are the same or have the same SSB index.
5. All the SSBs in a SSB burst are QCLed or have the same SSB index.

In some embodiments, the SSB detection performance may be improved by combining more SSBs in the initial access. Two methods may be considered:
1. Reduce the assumed SSB period in the initial access. Then, within 80 ms, more SSB bursts are transmitted. UE can combine more repetitions of SSBs to achieve better detection performance.
2. Increase the update period of MIB. Currently, the update period of MIB is 80 ms. Hence, SSB combination can only be performed within 80 ms. By increasing the MIB period, more SSB bursts can be transmitted with fixed SSB period. UE can combine more repetitions of SSBs to achieve better detection performance.

### III. Embodiment 2

Improvement of PDCCH detection.

In legacy NR, the aggregation level is at most AL=16 and the REG bundle size is at most L=6. The aggregation level indicates how many CCEs are used for transmission of a PDCCH. And each CCE contains 6 REGs. With larger aggregation level, more resources will be used for transmission, which means lower code rate and better detection performance. The REG bundle size indicates how many REGs are contained in a REG bundle. The interleaving is performed based on REG bundle. Moreover, the pre-coding within REG bundle is the same. Hence, JCE can be performed within a REG bundle. With larger REG bundle size, the channel estimation in low SNR region can be more accurate, which means better detection performance.

Note that when aggregation level or CCE size is increased, more time-frequency resources need to be occupied. However, the bandwidth used for PDCCH transmission may be limited. Hence, using more time domain, e.g., more OFDM symbols, to transmit one PDCCH needs to be considered. In the current standard, at most 3 OFDM symbols can be used for one PDCCH transmission. In order to support larger AL and CCE, more OFDM symbols for one PDCCH transmission should be supported.

In order to increase the PDCCH detection performance, the following methods may be considered:
1. Increase the resources used for PDCCH transmission through at least one of the following:
(1) Increase aggregation level;
(2) Increase CCE size.
2. Increase the resources used for JCE through at least one of the following:
(1) Increase REG bundle size;
(2) Assume multiple REG bundles are interleaved together (if interleaving is applied) and use the same pre-coding;
(3) Assume multiple CCEs can be bundled, where the CCEs in the bundle share the same pre-coding.

Note that when CCE size or REG bundle size is increased, the CCE-to-REG mapping method also needs to be updated. In legacy standard specification, the CCE-to-REG mapping for a control-resource set can be interleaved or non-interleaved and is described by REG bundles:
REG bundle i is defined as REGs {iL, iL+1, . . . , iL+L−1} where L is the REG bundle size, i=0,1, . . . , N_{REG}^{CORESET}/L−1, and N_{REG}^{CORESET}=N_{RB} ^{CORESET}N_{symb}^{CORESET} is the number of REGs in the CORESET.
CCE j consists of REG bundles {f(6j/L), f(6j/L+1), . . . , f(6j/L+6/L−1)} where f(·) is an interleaver.

When larger CCE size or REG bundle size is supported, CCE j consists of REG bundles {f(L_{C}j/L), f(L_{C}j/L+1), . . . , f(L_{C}j/L+L_{C}/L−1)} where f(·) is an interleaver, L_{C} is the supported CCE size, and L is the REG bundle size.

To support the above methods, additional signaling and configurations may be needed:
1. To support larger aggregation level, at least one of the following may be supported:
(1) Network indicates new larger AL level (e.g., 18, 20, 32, 64) to UE through MIB broadcast, SIB broadcast, or dedicated RRC signaling;
(2) Network indicates a scaling factor to UE (e.g., 2, 4) through MIB broadcast, SIB broadcast, or dedicated RRC signaling. The actual AL level is the product of AL level indicated in legacy signaling and the scaling factor.
2. To support larger CCE size, at least one of the following may be supported:
(1) Network indicates CCE size to UE through MIB broadcast, SIB broadcast, or dedicated RRC signaling;
(2) Network indicates a scaling factor to UE (e.g., 2, 4) through MIB broadcast, SIB broadcast, or dedicated RRC signaling. The number of REGs in a CCE is the product of 6 and the scaling factor.
3. To increase REG bundle size, at least one of the following may be supported:
(1) Network indicates new larger REG bundle size (e.g., 12, 16,24) to UE through MIB broadcast, SIB broadcast, or dedicated RRC signaling;
(2) Network indicates a scaling factor to UE (e.g., 2, 4) through MIB broadcast, SIB broadcast, or dedicated RRC signaling. The REG bundle size is the product of legacy REG bundle size and scaling factor.
4. To enable the case where multiple REG bundles are used, at least one of the following may be supported:
(1) Network indicates the number of REG bundles that can be used to perform JCE;
(2) Network indicates the number of REG bundles that are regarded as a unit of interleaving and share the same pre-coding.
5. To support a larger number of OFDM symbols for PDCCH transmission, at least one of the following may be supported:
(1) Network indicates a new larger number of OFDM symbols for PDCCH transmission through MIB broadcast, SIB broadcast, or dedicated RRC signaling;
(2) Network indicates a larger number of OFDM symbols for PDCCH transmission is supported through MIB broadcast, SIB broadcast, or dedicated RRC signaling;
(3) At least one new PDCCH search space is defined with a larger number of OFDM symbols.
6. To enable the CCE bundling, at least one of the following may be supported:
(1) Network indicates the CCE bundle size to UE through MIB broadcast, SIB broadcast, or dedicated RRC signaling;
(2) The CCEs in the same bundle share the same pre-coding;
(3) The REG bundle size is by default 6, or by default the CCE size.

Moreover, in legacy NR, PDCCH repetition is not allowed. By enabling the PDCCH repetition, the coverage performance can also be enhanced. Note that the PDCCH repetition may not be attached with a PDSCH for each repetition. In such case, network will repetitively transmit the same PDCCH via at least one of the following methods:
1. Periodically transmit repetitions of PDCCH with period At. The period can be equal to the time domain width of PDCCH, i.e., there is zero interval between PDCCH repetitions.
2. Transmit multiple repetitions of PDCCH in a certain pattern, where the intervals between different repetitions may not be same.

When PDCCH repetition is enabled, the RAR window for Msg2 should be extended. Otherwise, UE may not able to successfully receive repetitions of PDCCH scheduling Msg2. The RAR window may be extended via at least one of the following methods:
1. Network indicates the number of repetitions of PDCCH. The RAR window is extended by multiplying the original RAR window with the repetition number. That is, L.
2. Network indicates the number and period of PDCCH repetition. The RAR window is extended with an offset, where the offset is the product of the repetition number and the repetition period.
3. Default repetition number or repetition period of PDCCH may be defined. In some embodiments, the RAR window is extended by multiplying the original RAR window with the repetition number. In some embodiments, the RAR window is extended with an offset, where the offset is the product of repetition number and repetition period.

Besides, when Msg1 (PRACH preamble) repetition is enabled, RAR window extension is also expected. Otherwise, the RAR may be missed. In some embodiments, the RAR window may be extended via at least one of the following methods:
4. Network indicates the number of repetition of PRACH preamble. The RAR window is extended by multiplying the original RAR window with the repetition number.
5. Network indicates the number and period of PRACH preamble. The RAR window is extended with an offset, where the offset is the product of repetition number and repetition period.
6. Default repetition number or repetition period of PRACH preamble may be defined. In some embodiments, the RAR window is extended by multiplying the original RAR window with the repetition number. In some embodiments, the RAR window is extended with an offset, where the offset is the product of repetition number and repetition period.

### IV. Embodiment 3

Improvement of PDSCH detection.

In NTN, due to poor link budget and power flux density limit, legacy PDSCH detection may fail. In order to improve the detection performance, more frequency redundancy may be introduced. At least one of following methods can be considered:
1. Frequency domain repetition. In 3GPP, time domain repetition of PDSCH has been supported. However, frequency domain repetition has not. In this method, UE may repeat the same TB in multiple subbands. Network can combine the repetition in frequency domain in decoding to obtain better performance.
2. Introducing lower code rate in MCS/TBS table. In current MCS/TBS table, the code rate may not be low enough. If we want to use more frequency resources to transmit one TB, lower code rate may need to be introduced in MCS/TBS table. Or we should define a new MCS/TBS table specifically for bad coverage scenario such as NTN.

### V. Embodiment 4

Msg4 repetition.

In RACH procedure, network will transmit Msg4 to UE in response to Msg3 to resolve the contention. In NTN, the detection of Msg4 may fail due to poor link budget and power flux density limit. In order to improve the performance, time domain repetition may be introduced for Msg4. However, when repetition is introduced, longer time is needed for UE to receive Msg4. As a result, the ra-ContentionResolutionTimer may be expired when UE is receiving repetitions of Msg4. In order to avoid this case, the ra-ContentionResolutionTimer can be extended though the following methods:
3. Add an additional larger candidate value for ra-ContentionResolutionTimer configuration.
4. The ra-ContentionResolutionTimer length is additionally extended with an offset. The offset may be at least one of the following:
(1) configured repetition duration of Msg4 or configured repetition duration of Msg4 minus the duration of 1 repetition.
(2) maximum supported repetition duration of Msg4 or maximum supported repetition duration of Msg4 minus the duration of 1 repetition.
(3) configured repetition number of Msg4 or configured repetition number of Msg4 minus 1.
(4) maximum supported repetition number of Msg4 or maximum supported repetition number of Msg4 minus 1.

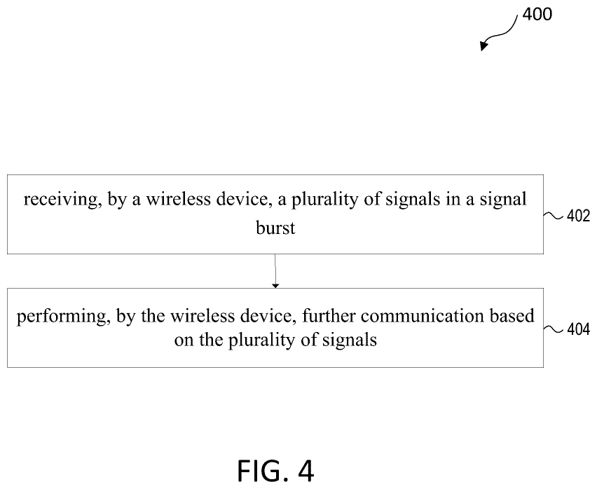

FIG. 4 is an exemplary flowchart for reception of a number of signals. Operation 402 includes receiving, by a wireless device, a number of signals in a signal burst. Operation 404 includes performing, by the wireless device, further communication based on the number of signals. In some embodiments, the method can be implemented according to Embodiment 1. In some embodiments, performing further communication can be based on a lower code-rate and a better decoding performance than a legacy protocol.

In some embodiments, the number of signals includes at least one of a Synchronization Signal Block (SSB) transmission or a Physical Broadcast Channel (PBCH) transmission. In some embodiments, the number of signals in the signal burst are Quasi-Co-Located (QCLed). In some embodiments, the number of signals in the signal burst has a same SSB index. In some embodiments, the number of signals in the signal burst are identical.

In some embodiments, receiving the number of signals includes receiving, by the wireless device, the number of signals in a time window. In some embodiments, receiving the number of signals includes receiving, by the wireless device, the number of signals in a pattern. In some embodiments, the number of signals in the time window are QCLed. In some embodiments, the number of signals in the time window has a same SSB index. In some embodiments, the number of signals in the time window are identical.

In some embodiments, the time window is predefined or prestored at the wireless device. In some embodiments, the time window is based on a time window length table. In some embodiments, the method further includes determining, by the wireless device, the time window based on a type of a network or a wireless node. In some embodiments, the method further includes receiving, by the wireless device, the time window via a signaling. In some embodiments, the signaling includes a Radio Resource Control (RRC) signaling or a System Information Block (SIB) signaling.

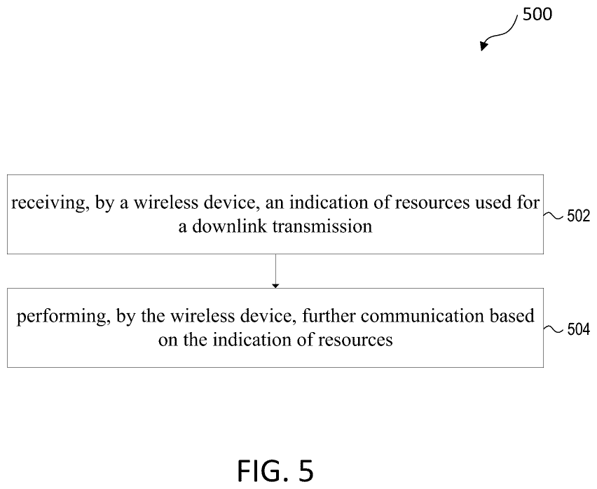

FIG. 5 is an exemplary flowchart for reception of an indication of resources. Operation 502 includes receiving, by a wireless device, an indication of resources used for a downlink transmission. Operation 504 includes performing, by the wireless device, further communication based on the indication of resources. In some embodiments, the method can be implemented according to Embodiment 2. In some embodiments, performing further communication can be based on a lower code-rate and a better decoding performance than a legacy protocol.

In some embodiments, the downlink transmission includes a Physical Downlink Control Channel (PDCCH) transmission. In some embodiments, receiving the indication includes receiving a scaling factor associated with an Aggregation Level (AL). In some embodiments, receiving the scaling factor associated with the AL includes receiving the scaling factor associated with the AL via at least one of a Master Information Block (MIB) broadcast, a System Information Block (SIB) broadcast, or a Radio Resource Control (RRC) signaling. In some embodiments, receiving the indication includes receiving a value associated with an Aggregation Level (AL) for a Non-Terrestrial Network (NTN). In some embodiments, receiving the value associated with the AL for the NTN includes receiving the value associated with the AL for the NTN via at least one of a MIB broadcast, a SIB broadcast, or a RRC signaling.

In some embodiments, receiving the indication includes receiving a scaling factor associated with a Control Channel Element (CCE) size. In some embodiments, receiving the scaling factor associated with the CCE size includes receiving the scaling factor associated with the CCE size via at least one of a MIB broadcast, a SIB broadcast, or a RRC signaling. In some embodiments, receiving the indication includes receiving a value associated with a Control Channel Element (CCE) size for a Non-Terrestrial Network (NTN). In some embodiments, receiving the value associated with the CCE size for the NTN includes receiving the value associated with the CCE size for the NTN via at least one of a MIB broadcast, a SIB broadcast, or a RRC signaling.

In some embodiments, receiving the indication includes receiving a scaling factor associated with a Resource Element Group (REG) bundle size. In some embodiments, receiving the scaling factor associated with the REG bundle size includes receiving the scaling factor associated with the REG bundle size via at least one of a MIB broadcast, a SIB broadcast, or a RRC signaling. In some embodiments, receiving the indication includes receiving a value associated with a Resource Element Group (REG) bundle size for a Non-Terrestrial Network (NTN). In some embodiments, receiving the value associated with the REG bundle size for the NTN includes receiving the value associated with the REG bundle size for the NTN via at least one of a MIB broadcast, a SIB broadcast, or a RRC signaling.

In some embodiments, receiving the indication includes receiving a value associated with a count of Resource Element Group (REG) bundles for a Non-Terrestrial Network (NTN). In some embodiments, the REG bundles are a unit of interleaving. In some embodiments, the REG bundles share a same pre-coding.

In some embodiments, receiving the indication includes receiving a value associated with a CCE bundle size. In some embodiments, the CCE bundle is a unit of interleaving. In some embodiments, the CCEs in the CCE bundle share a same pre-coding.

In some embodiments, receiving the indication includes receiving a value associated with a symbol number for a Non-Terrestrial Network (NTN). In some embodiments, the symbol includes an Orthogonal Frequency Division Multiplexing (OFDM) symbol. In some embodiments, receiving the value associated with the symbol number for the NTN includes receiving the value associated with the symbol number for the NTN via at least one of a MIB broadcast, a SIB broadcast, or a RRC signaling. In some embodiments, the downlink transmission has a search space determined by the value associated with the symbol number for the NTN.

In some embodiments, receiving the indication includes receiving at least one of a repetition number or a repetition period. In some embodiments, the method further includes extending a Random Access Response (RAR) window by multiplying a RAR window length with the repetition number. In some embodiments, receiving the indication includes receiving an offset value associated with a Random Access Response (RAR) window. In some embodiments, the method further includes extending the Random Access Response (RAR) window by adding the offset value to a RAR window length.

In some embodiments, the method further includes receiving, by the wireless device, the downlink transmission periodically.

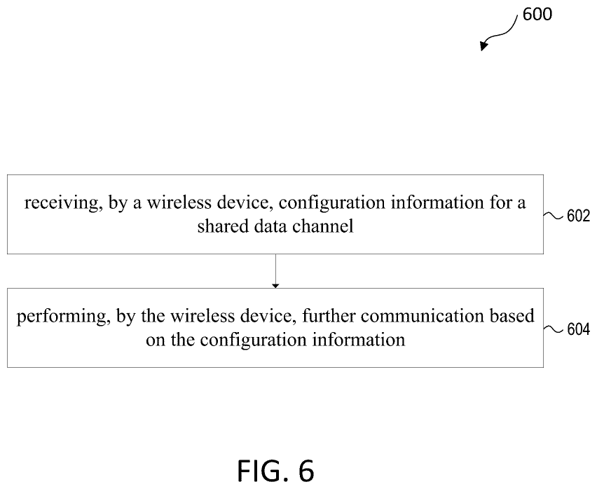

FIG. 6 is an exemplary flowchart for reception of configuration information. Operation 602 includes receiving, by a wireless device, configuration information for a shared data channel. Operation 604 includes performing, by the wireless device, further communication based on the configuration information. In some embodiments, the method can be implemented according to Embodiment 3. In some embodiments, performing further communication can be based on a lower code-rate and a better decoding performance than a legacy protocol.

In some embodiments, the shared data channel includes a Physical Data Shared Channel (PDSCH). In some embodiments, the configuration information includes at least one of a Modulation Coding Scheme (MCS), a Transport Block Size (TBS), or a frequency domain repetition configuration. In some embodiments, the method further includes receiving, by the wireless device, a transport block (TB) based on the configuration information. In some embodiments, receiving the TB includes receiving repetitions of a transmission of the TB in a frequency domain. In some embodiments, receiving the TB includes receiving repetitions of the TB in multiple sub-bands.

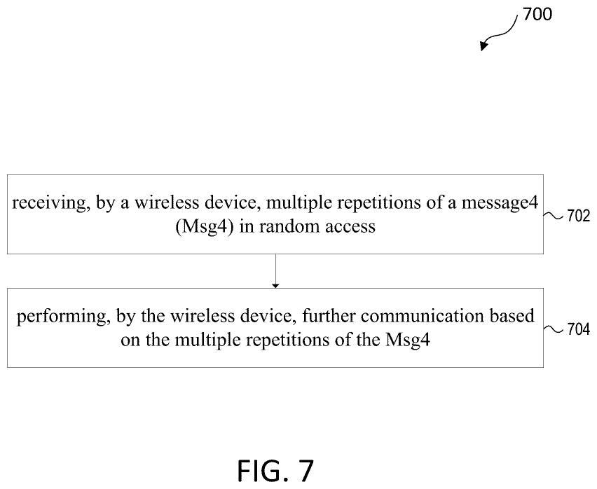

FIG. 7 is an exemplary flowchart for reception of data with multiple repetitions. Operation 702 includes receiving, by a wireless device, multiple repetitions of a message4 (Msg4) in random access. Operation 704 includes performing, by the wireless device, further communication based on the multiple repetitions of the Msg4. In some embodiments, the method can be implemented according to Embodiment 4. In some embodiments, performing further communication can be based on a lower code-rate and a better decoding performance than a legacy protocol.

In some embodiments, the method further includes receiving, by the wireless device, at least one signaling indicative of at least one of: a time offset associated with the Msg4; a repetition number of the Msg4; a maximum repetition number of the Msg4; a repetition duration of the Msg4; or a maximum repetition duration of the Msg4.

In some embodiments, a random access contention resolution timer associated with the random access is extended with at least one of: a time offset associated with the Msg4; a repetition number of the Msg4; a repetition number of the Msg4 minus 1; a maximum repetition number of the Msg4; a maximum repetition number of the Msg4 minus 1; a repetition duration of the Msg4; a repetition duration of the Msg4 minus a duration of a single repetition; a maximum repetition number of the Msg4; or a maximum repetition number of the Msg4 minus a duration of a single repetition.

In some embodiments, a method includes transmitting, by a network device, a number of signals in a signal burst and performing, by the network device, further communication based on the number of signals. In some embodiments, a method includes transmitting, by a network device, an indication of resources used for a downlink transmission and performing, by the network device, further communication based on the indication of resources. In some embodiments, a method includes transmitting, by a network device, configuration information for a shared data channel and performing, by the network device, further communication based on the configuration information. In some embodiments, a method includes transmitting, by a network device, multiple repetitions of a message4 (Msg4) in random access and performing, by the network device, further communication based on the multiple repetitions of the Msg4. Various embodiments of the network device may be configured to provide the various messages described with respect to FIGS. 4 to 7 to the wireless devices.

A device that is configured or operable to perform the above-described methods are within the scope and the spirit of this patent document.

In some embodiments, the above-described methods are embodied in the form of processor-executable code and stored in a non-transitory computer-readable storage medium. The code included in the computer readable storage medium when executed by a processor, causes the processor to implement the methods described in this patent document.

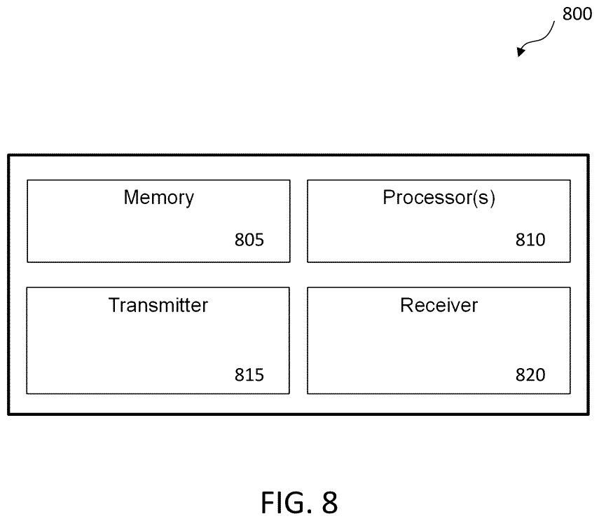

FIG. 8 shows an exemplary block diagram of a hardware platform 800 that may be a part of a network device (e.g., base station) or a communication device (e.g., a user equipment (UE)). The hardware platform 800 includes at least one processor 810 and a memory 805 having instructions stored thereupon. The instructions upon execution by the processor 810 configure the hardware platform 800 to perform the operations described in FIGS. 1 to 7 and in the various embodiments described in this patent document. The transmitter 815 transmits or sends information or data to another device. For example, a network device transmitter can send a message to a user equipment. The receiver 820 receives information or data transmitted or sent by another device. For example, a user equipment can receive a message from a network device. For example, a NTN, as described in the present document, may be implemented using the hardware platform 800.

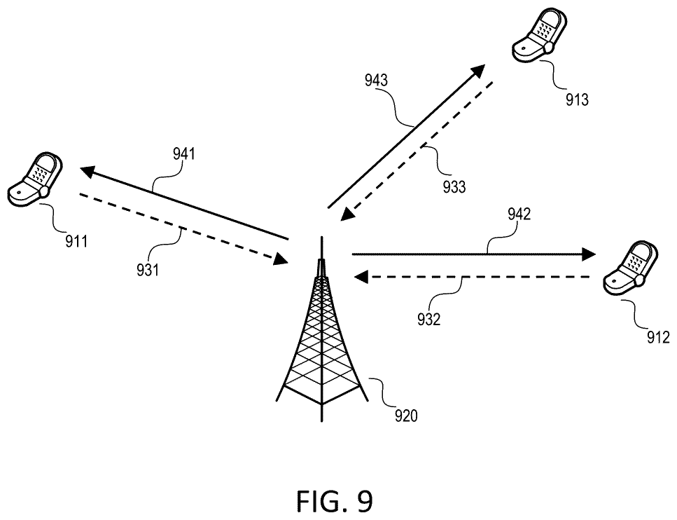

The implementations as discussed above will apply to a wireless communication. FIG. 9 shows an example of a wireless communication system (e.g., a 5G or NR cellular network) that includes a base station 920 and one or more user equipment (UE) 911, 912 and 913. In some embodiments, the UEs access the BS (e.g., the network) using a communication link to the network (sometimes called uplink direction, as depicted by dashed arrows 931, 932, 933), which then enables subsequent communication (e.g., shown in the direction from the network to the UEs, sometimes called downlink direction, shown by arrows 941, 942, 943) from the BS to the UEs. In some embodiments, the BS send information to the UEs (sometimes called downlink direction, as depicted by arrows 941, 942, 943), which then enables subsequent communication (e.g., shown in the direction from the UEs to the BS, sometimes called uplink direction, shown by dashed arrows 931, 932, 933) from the UEs to the BS. The UE may be, for example, a smartphone, a tablet, a mobile computer, a machine to machine (M2M) device, an Internet of Things (IoT) device, and so on. The NTN described in the present document may be communicatively coupled (e.g., as shown in FIG. 1) to UEs depicted in FIG. 9 thorough the base station 920.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub- combination. Moreover, although features may be described above as acting in certain combinations and even initially claimed as such, one or more features from a claimed combination can in some cases be excised from the combination, and the claimed combination may be directed to a sub- combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
receiving, by a wireless device, a plurality of signals in a signal burst; and
performing, by the wireless device, further communication based on the plurality of signals.

2. The method of claim 1, wherein the plurality of signals comprises at least one of a Synchronization Signal Block (SSB) transmission or a Physical Broadcast Channel (PBCH) transmission.

3. The method of claim 1, wherein the plurality of signals in the signal burst are Quasi-Co-Located (QCLed).

4. The method of claim 1, wherein the plurality of signals in the signal burst has a same SSB index.

5. The method of claim 1, wherein the plurality of signals in the signal burst are identical.

6. The method of claim 1, wherein receiving the plurality of signals comprises receiving, by the wireless device, the plurality of signals in a time window.

7. The method of claim 1, wherein receiving the plurality of signals comprises receiving, by the wireless device, the plurality of signals in a pattern.

8. The method of claim 6, wherein the plurality of signals are Quasi-Co-Located (QCLed).

9. The method of claim 6, wherein the plurality of signals has a same SSB index.

10. The method of claim 6, wherein the plurality of signals are identical.

11. The method of claim 6, wherein the time window is predefined or prestored at the wireless device.

12. The method of claim 6, wherein the time window is based on a time window length table.

13. The method of claim 6, further comprising:
determining, by the wireless device, the time window based on a type of a network or a wireless node.

14. The method of claim 6, further comprising:
receiving, by the wireless device, the time window via a signaling.

15. The method of claim 14, wherein the signaling comprises a Radio Resource Control (RRC) signaling or a System Information Block (SIB) signaling.

16. A method of wireless communication, comprising:
sending, by a wireless node to a wireless device, a plurality of signals in a signal burst,
wherein further communication is performed by the wireless device based on the plurality of signals.

17. A wireless node, comprising:
at least one processor configured to:
send, via a transmitter to a wireless device, a plurality of signals in a signal burst,
wherein further communication is performed by the wireless device based on the plurality of signals.

18. A wireless device, comprising:
at least one processor configured to:
receive, via a transceiver, a plurality of signals in a signal burst; and
perform, via the transceiver, further communication based on the plurality of signals.

19. The wireless device of claim 18, wherein the plurality of signals comprises at least one of a Synchronization Signal Block (SSB) transmission or a Physical Broadcast Channel (PBCH) transmission.

20. The wireless device of claim 18, wherein the plurality of signals in the signal burst are Quasi-Co-Located (QCLed).
